(19) United States
(12) Patent Application Publication
(10) Pub. No.: US 2026/0243354 A1
(43) Pub. Date: Aug. 20, 2026

(54) Top-Entry Ball Valve with Pressure Seal Bonnet for Power and Nuclear Applications

(71) Applicant: Velan Inc., Montreal (CA)

(72) Inventors: Nicolas Hervé François LOURDEL, Montreal (CA); Michel Sylvain Mario Paquin, Sainte-Cécile de Milton (CA); Paul Major, Pierrefonds (CA); Ashit Mukeshbhai Patel, Hampstead (CA); Zakaria Mohamed El Yacoubi El Idrissi, Montreal (CA); Michael Joseph Jacobs, Hinesburg, VT (US)

(21) Appl. No.: 19/239,257

(22) Filed: Jun. 16, 2025

Related U.S. Application Data
(63) Continuation of application No. PCT/US2024/060344, filed on Dec. 16, 2024.
(63) Continuation-in-part of application No. 17/985,474, filed on Nov. 11, 2022, now Pat. No. 12,331,848.
Application No. 17/985,474 is a continuation-in-part of application No. 17/921,528, filed on Apr. 27, 2021, now Pat. No. 12,181,063.
(60) Provisional application No. 63/016,423, filed on Apr. 28, 2020.
(60) Provisional application No. 63/610,757, filed on Dec. 15, 2023.
(60) Provisional application No. 63/612,236, filed on Dec. 19, 2023.
(60) Provisional application No. 63/552,452, filed on Feb. 12, 2024.

(51) Int. Cl. F16K 5/06

(52) U.S. Cl. CPC F16K 5/0636; F16K 5/0689

(57) ABSTRACT

A compact and lightweight two-piece valve shell (body and pressure seal bonnet) structure reduces possible leakage paths while also providing a top-side ball/stem installation/removal path (when the bonnet piece is not present) to facilitate initial valve assembly as well as subsequent inspection/removal of the ball/stem and other valve internals for conducting valve maintenance without requiring the valve body to be removed from its process connections and without removing the bracket and actuator. Sealing seats can be adjusted in overall length using fluid, vacuum, threads or cams to ease the assembly of the ball inside the body. The sealing seat adjustment can be completed with the ball inside or outside the body cavity.

### CROSS-REFERENCES TO RELATED APPLICATIONS

This application is a continuation application of International Application No. PCT/US2024/060344 filed Dec. 16, 2024 which claims the benefit of priority from U.S. Provisional Patent Application No. 63/610,757 filed on Dec. 15, 2023, U.S. Provisional Patent Application No. 63/612,236 filed on Dec. 19, 2023, and U.S. Provisional Patent Application No. 63/552,452 filed on Feb. 12, 2024. This application is also a continuation-in-part application of U.S. application Ser. No. 17/985,474 filed Nov. 11, 2022, which is a continuation-in-part application of U.S. application Ser. No. 17/921,528 filed Oct. 26, 2022 (now U.S. patent Ser. No. 12/181,063). U.S. application Ser. No. 17/921,528 is a U.S. national stage application of International Application No. PCT/IB2021/053479 filed on Apr. 27, 2021, which claims priority from U.S. Provisional Patent Application No. 63/016,423 filed Apr. 28, 2020. The entire content of each of the above applications are hereby incorporated by reference.

### TECHNICAL AREA

This disclosure is directed to valves for severe service applications, and more particularly, for valves for power industry applications including nuclear applications.

### BACKGROUND

This application is directed to a top-entry ball valve design especially useful, for example, as Main Steam Isolation Valves and Feedwater Valves in nuclear or other power industries. Valves used in nuclear service applications should be constructed to handle high seismic loads, pressures and temperatures. The valves should provide high actuator margins, and should withstand high thrust and torque requirements. Flow could be saturated steam, superheated steam, steam condensate, water and gas. The main challenges are the high temperature, high pressure service, thermal cycling due to on-off operation of Power Plant, material selection, fatigue, wear of the sealing surfaces. Some power applications such as A-USC (Advanced Ultra-Supercritical Power) imply operation of steam temperatures up to 760 deg. C. and pressures up to 37.5 MPa.

Top-entry valve designs may be highly suited for use in the power industry, particularly in the nuclear industry, because a top-entry valve possesses several characteristics that are desired in valves in power industry applications, such as, for example, ease of maintenance, one body piece from inlet pipe connection to outlet pipe connection, and high levels of reliability, safety, and durability.

Top-entry valves have a one-piece body and a top cover often referred to as a bonnet. A key advantage of top-entry valves is that they can be maintained without removing the complete valve from the pipeline. The top bonnet of the valve, when removed, allows for direct access to the internals of the valve. This feature is particularly valuable in nuclear applications where minimizing downtime and exposure to hazardous environments is critical. In a radioactive environment, the maintenance time and exposure time to radiation are highly controlled and must be as short as possible for maintenance operators.

The one-piece body of the top-entry valve ensures that there is no seal along the waterway. Only the body piece is attached to the inlet pipe and the outlet pipe. In the case of inlet or outlet piping stresses, there is no risk of leakage in the body piece. This is in contrast to valve designs that have a seal between two or three components forming a body when assembled together which are at risk of leakage at their interfaces, (e.g., when the plant is starting up and there is gradient of temperatures in the process line).

By eliminating all seals between components forming a valve body assembly, there is no need for large mechanical connection to clamp the seals. This results in a one-piece body with optimized wall thickness from the valve inlet pipe connection to its outlet pipe connection. This helps in saving space and weight, which are often constraints in nuclear facilities. This also helps at keeping homogeneous thermal and mechanical stresses from the inlet pipe connection to the outlet pipe connection which are key for increasing the life expectancy of the valve shell and meeting all mechanical safety precautions.

The robust construction of top-entry valves ensures reliable sealing and operation under high-pressure and high-temperature conditions, which are common in power plants. Because the internals (e.g., ball, seats and stems) are inserted from the top bonnet end, the constraints in dimensions especially in critical dimensions to bear high operating pressure, torque and temperature, are less restrictive than a side-entry ball valve design.

The ability to perform maintenance without valve removal from the process line reduces the risk of exposure to radioactive materials and other hazards, enhancing overall safety for maintenance personnel. Moreover, top-entry valves are designed to withstand the harsh conditions of nuclear environments, including exposure to radiation and corrosive substances.

Ball valve designs have advantages in the power industry for several reasons such as, for example, better flow resistance, quick opening or closing, tight sealing between ball and seats, amenability to the use of technologies to increase the service life, durability and longevity, versatility, high pressure and temperature tolerance.

Ball valves have a low flow resistance due to their full-bore design without geometries in their flow path when fully open. This results in minimal pressure drop and a maximum of efficiency for the power plant.

Ball valves can be opened and closed quickly with a 90-degree turn of the ball. This quick operation is crucial in power applications where rapid response times are necessary in case of emergency.

A reliable, gas-tight seal can be provided in ball valves including metal seated ball valves. Most of the ball valves are designed with a ball to seat contact working as an autoclave. Basically, the higher the pressure on the valve inlet, the higher will be the induced pressure of contact between the sealing surface of the seat and the ball, the higher will be shut-off. This is a highly desired feature in power plants to prevent leaks of high-pressure steam or other fluid.

Ball valves in power applications such as steam applications use hard materials (e.g., coating, welding, plating, diffusion) on the ball, seats sealing surfaces as well as on the bearing surfaces (e.g., thrust washers, and trunnions) in order to enhance the bearing stress capability, reduce the wear over the valve cycling life, and maintain high tight shut-off over time.

When the ball is fully open, there is no element used for sealing purposes in the flow bore hence, the sealing surfaces are less likely to wear out because they are not in direct contact with the fluid. In addition, because there is no element in the flow bore, there is no perturbation of the flow such as pressure drop that could create cavitation in water service or affect the efficiency of the plant. This minimizes the risk of wear such as erosion or steam cut that could affect the sealing performance over time.

Severe service ball valves are versatile and can handle a wide range of fluids, including liquids, steam, gas, and slurries. This makes them suitable for various applications within power plants, from controlling steam flow to managing cooling water.

Ball valves can operate effectively under high pressure and temperature conditions or with a significant gradient of temperature between the internals and the ball valve body. This makes them ideal for applications involving high-pressure steam, hot water, thermal shocks and/or rapid cooling.

For these reasons, the choice of top-entry ball valves for use in power plants, including in nuclear power plants, is attractive.

FIG. 1 illustrates a conventional top-entry ball valve. The body 101 of the top-entry ball valve is a single piece, which houses all the internal components including the sealing components such as ball 103 and seats 104. The seats are arranged one on each side of the ball. The bonnet 102 is the part of the valve that covers the body internal cavity where the ball and seats are located. The bonnet is usually attached to the valve body using a bolted flange connection (e.g., using studs 113 and nuts 114) and a seal 110 in-between the body and the bonnet to prevent any leakage. The top entry bonnet allows access to the internal components of the valve without removing the complete valve from the pipeline. For example, access to the internals can be obtained by removing the bonnet 102. The height of the bonnet can be adjusted depending on the temperature of the process media. The more extreme is the temperature (high or low), the longer should be the bonnet to protect the packing rings (111b) and O-rings (111c).

The seal 110 works in compression to ensure that there is no leak between the body 101 and bonnet 102. In top-entry valves and valves in general, the body 101, bonnet 102 and the bolted flange connection are designed to induce a minimum compressive stress on the seal 110 to fill all the voids between the body 101, the seal 110 and the bonnet 102 surfaces and to ensure that there is no body/bonnet leakage at low pressure (seating load and stress). The top-entry valves and valves in general are also designed to induce a compressive load on the seal several times the internal load created by the internal pressure of the valve (maintenance factor). The load to be developed by the bolted flange connection is not linearly related to the diameter of the seal. It is rather proportional to the square of the seal diameter to counter the hydrostatic end load in addition to being linearly related to the seal diameter to develop the gasket seating load.

The ball 103 is the main component that controls or isolates the flow in the top-entry valve and ball valves in general. The ball 103 has a hole through its center similar in size to the body inlet and outlet bores. When the ball 103 is rotated 90 degrees by the valve handle or actuator, it either allows flow through the bore or blocks it. The ball can either be floating, i.e. only maintained in position by the seats 104, or be supported by trunnions bearings on its top and bottom (e.g., with lower trunnion bearing 120b and upper trunnion bearing 120c).

The seats 104 are located on either side of the ball and provide a tight seal when the valve is closed. Several components such as the spring holder ring 104a, and the seat springs 116a are used to preload the seats 104 against the ball 103 which induces enough bearing stress between ball 103 and seats 104 to tight seal at low pressure.

On the external diameter of the seat 104, there is a seat gasket 111d usually pressure energized (i.e., it requires pressure to seal). By adjusting the seat gasket 111d external diameter to be larger than the ball to seat sealing diameter, the pressure energized effect of the seat to ball contact can be made positive, meaning that the higher the inlet pressure, the higher the preload between the ball and the seat will be and the higher the pressure at which the ball to seat contact will seal.

The stem 105 connects the ball to the handle or actuator. It is responsible for transmitting the rotational motion and the required torque to open or close the ball 103 to control the flow through the valve. The stem is typically sealed with O-rings or packing rings (111b for packing rings and 111c for O-rings) to prevent leaks.

The O-rings 111c and packing rings 111b make the stem component a pressure retaining part and make the stem act like a piston attempting to exit the valve. The higher the pressure inside the valve or the larger the diameter of the stem in contact with the O-rings (111c) and packing rings (111b), the higher the thrust load will act on the stem and try to push the stem out of the valve.

To prevent the stem 105 from exiting the valve, the stem 105 is designed as a shaft with different diameters along its main axis and with the larger diameter at its bottom. The larger stem diameter is in contact with a stem thrust washer 121a and the bonnet 102.

The thrust washers are designed to support high bearing load created by the internal pressure and the resulting stem thrust. These thrust washers are also used as stem guide bushing to ensure that the stem always stays concentric with the bonnet and the packing rings or O-rings. A lack of concentricity may lead to stem (105) and packing rings (111b) side-loading, premature packing rings or O-rings leakage and potential wear between the bonnet and the stem increasing the overall valve operating torque.

There are limitations of a standard top-entry ball valve design. For example, the larger the diameter of the valve flow bore, the larger will be the ball sphere. The top opening of the body 101 and the diameter of the seal 110 between the body 101 and the bonnet 102 will increase consequently to allow for ball 103 insertion. Because the gasket compression is dependent on its diameter, the required body/bonnet load and bolting to compress the seal can increase significantly for large size ball bores. For large size top-entry ball valves, such as those that are required for effective use in power applications, this makes heavy bolted body and bonnet connections.

FIG. 2 and FIG. 3 illustrate example conventional multi-turn valves that could also be used in power and nuclear applications. FIG. 2 illustrates a pressure sealing body/bonnet multi-turn valve and FIG. 3 illustrates a bolted body/bonnet multi-turn valve. The same issue of body/bonnet connection size increase also exists for bolted bonnet multi-turn valves. The larger the wedge (303) or the parallel slide disc wedge (203) used to block the flow inside the valve body (e.g., 201, 301), the larger will be the required seal between the multi-turn valve bolted body and the bonnet (e.g., 202, 302), the higher will be the required compression load of the seal to ensure no leakage occurs between the bolted body (e.g., 201, 301) and the bonnet. In the case of the bolted bonnet configuration (FIG. 3), the larger will be size or the quantity of the bolted bonnet studs (311b) and nuts (311a).

For large multi-turn valves (e.g., pressure class 900 or above, sizes NPS8 and above), one of the multi-turn valve industry trends is to switch from a bolted-bonnet design (FIG. 3) to a pressure seal bonnet design (FIG. 2).

A pressure seal multi-turn valve design is similar to a bolted-bonnet valve design except for the body/bonnet connection and seal. It includes the same internals such as a wedge (303) or a parallel slide disc wedge (203) to block the flow and is operated by a stem (205, 305). The pressure seal bonnet 202 is floating and free to move along the stem axis while the pressure seal gasket 207 is encapsulated between the bonnet 202, a spacer ring 206 and a gasket retainer 208.

A pressure seal bonnet (e.g., 202) functions by utilizing the internal pressure of the valve to enhance the sealing capability. For example, the pressure seal bonnet (e.g. 202) is pressed against a pressure seal gasket (e.g., 207) by the initial tightening of the pressure seal bonnet studs and nuts (e.g., studs 211a and nuts 211b). This creates initial sealing barriers between the pressure seal gasket internal diameter (gasket ID) and bonnet as well as between the pressure sealing gasket outer diameter (gasket OD) and body, enough to seal against low internal pressure.

As the internal pressure of the fluid in the valve increases, it pushes the bonnet upwards against the gasket. This pressure enhances the seal, making the seal tighter. In essence, the higher the internal pressure, the tighter the sealing barrier becomes.

Unlike bolted bonnets, which rely solely on the mechanical force of the body/bonnet bolts, pressure seal bonnets use a retainer system (e.g., pressure seal bonnet retainer 209 and pressure seal gasket retainer 208) to maintain and improve the seal. This makes them particularly effective in high-pressure applications, as the seal strength increases with the pressure.

Compared to a multi-turn bolted bonnet design, the pressure seal design only needs the pressure seal studs and nuts for an initial preload of the pressure seal gasket. This means that the size and quantity of the pressure seal studs and nuts could be significantly reduced compared to a bolted bonnet joint. In addition, the pressure seal studs and nuts can be equally distributed on a diameter smaller than the pressure seal internal diameter while the studs (311b) and nuts (311a) of a bolted bonnet joint are usually equally distributed on a diameter larger than the joint seal (310). This allows for making the pressure seal design more compact and lighter than an equivalent bolted bonnet design.

### BRIEF DESCRIPTION OF THE DRAWINGS

FIG. 1 is an isometric partially sectioned depiction of a conventional top-entry ball valve.

FIG. 2 is an isometric partially sectioned depiction of another conventional multi-turn valve structure with a pressure seal bonnet and a parallel slide disc wedge.

FIG. 3 depicts yet another conventional multi-turn valve structure with a bolted bonnet and a wedge.

FIG. 4A conceptually depicts a top-entry ball valve with pressure seal bonnet according to some embodiments of the present disclosure, as a combination of a conventional top-body ball valve with bolted bonnet and a conventional pressure seal bonnet multi-turn valve.

FIG. 4B conceptually depicts the diameter of a bolted bonnet in comparison with a pressure seal bonnet according to some embodiments of same valve flow bore size and pressure class.

FIG. 5A is a top-entry ball valve with pressure seal bonnet according to some embodiments of this disclosure.

FIG. 5B illustrates a valve similar to the valve shown in FIG. 5A, but with the step inverted.

FIG. 6A is a top-entry ball valve with pressure seal bonnet according to some other embodiments of this disclosure.

FIG. 6B illustrates a valve similar to the valve shown in FIG. 6A, but with the stem inverted.

FIG. 7A and FIG. 7B illustrate example installation processes for the ball in a top-entry ball valve with pressure seal bonnet, according to some embodiments of this disclosure.

### DETAILED DESCRIPTION OF EXAMPLE NON-LIMITING EMBODIMENTS

As described above, the conventional top-entry ball valves can be improved for better performance in power applications such as, for example, nuclear applications. The inventors set out to adapt the top-entry ball valve for more optimal use in highly demanding nuclear power applications. Example embodiments make the top-entry ball valve more compact and reduces its overall weight. A lighter valve is beneficial for the piping arrangement around the valve as it reduces the mechanical stresses in general and in case of accidents such as seismic events.

In order to construct a top-entry ball valve that can more optimally service the high temperature and pressure demands of power applications including, for example, nuclear applications, the inventors constructed a top-entry ball valve with pressure seal bonnet. The ball valve design with a pressure seal bonnet is a unique and innovative solution developed for use in environments such as, but not limited to, Small Modular Reactors (SMR) and other advanced nuclear reactor applications. This design leverages the inventors' extensive experience in nuclear and severe service valve solutions, combining features of nuclear valves such as pressure seal valve technologies, with ball and seat arrangement for high temperature and high-pressure severe service applications.

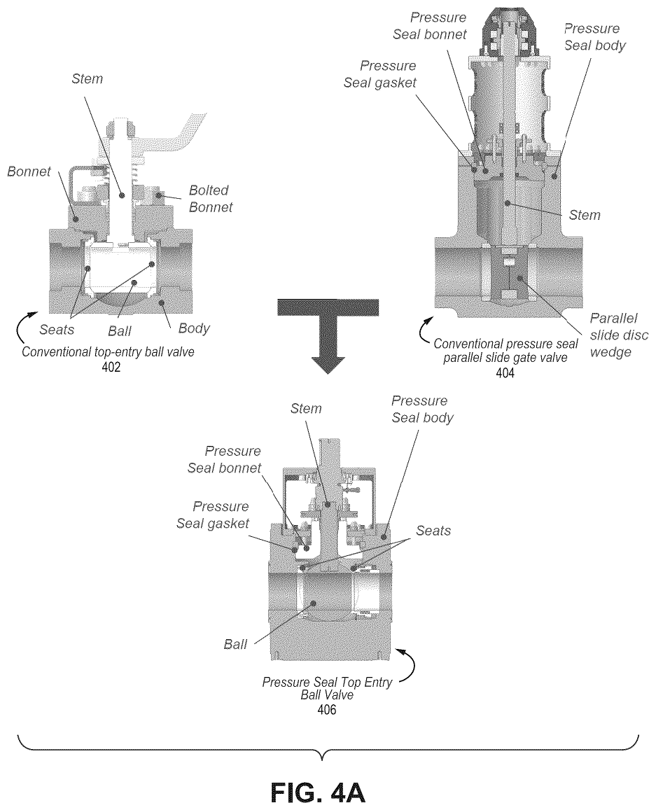

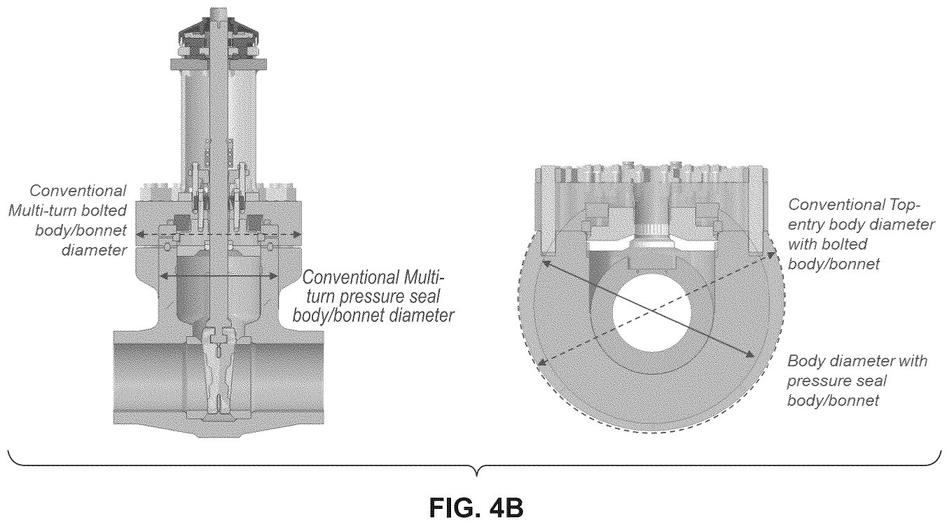

FIG. 4A conceptually illustrates the combination of design concepts from a conventional top-entry ball valve 402 and a conventional multi-turn pressure seal bonnet 404 to construct a top-entry ball valve incorporating a pressure seal bonnet 406 according to an embodiment of the present disclosure. FIG. 4B illustrates an example comparative reduction in the joint diameter of a pressure seal bonnet valve when compared to a bolted bonnet joint for a multi-turn valve (on the left) and a top-entry ball valve (on the right).

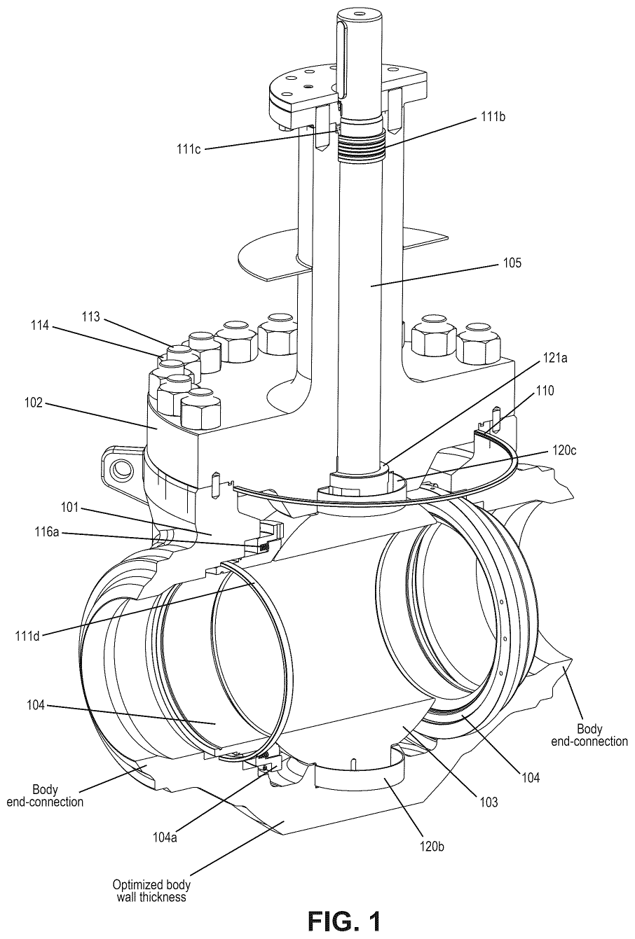

However, for a standard top-entry ball valve design such as that shown in FIG. 1, simply replacing the bolted joint connection and bonnet design with a pressure seal gasket and floating bonnet design leads to valves with undesirable characteristics such as potential leaks, increased operating torques, accelerated wear of sealing surfaces, etc. Several challenges are encountered in forming a top-entry ball valve with a pressure seal bonnet according to embodiments that is suited for use in nuclear service and other power industry applications.

Because the floating pressure seal bonnet is free to move along the stem axis and the bonnet pushes the pressure seal gasket with the internal pressure, one of the challenges in forming a top-entry ball valve with a pressure seal bonnet is that the contact between the stem with the internal thrust washer and the bonnet may not be maintained. In the scenario where the contact is not maintained, the thrust washers used to guide the bottom of the stem would be unable to accomplish this function. This can lead to premature wear of the stem packing rings or O-rings resulting in leakage.

Even in a scenario where the contact is maintained between the stem with the internal thrust washer and the bonnet, the stem and the thrust washer travel along the stem axis in the same manner as the bonnet. This would reduce the surface of contact between the ball and stem and, consequently, reduce the maximum torque that the stem can transmit to the ball without damaging the two components.

Because of the floating pressure seal bonnet being free to move along the stem axis and the bonnet pushing the pressure seal gasket with the internal pressure, the upper trunnion bearing guided by the bonnet on its external diameter is also free to move along the stem axis. The contact pressure between the ball upper trunnion and its mating trunnion bearing is carefully designed to support the internal loads induced by seat spring preload and the valve medium pressure to ensure minimum wear during the ball stroke operations. In the case where the trunnion bearing and the pressure seal bonnet move together along the stem axis, the surface of contact between the ball upper trunnion and mating bearing would be reduced. That can induce a significant increase of the bearing stresses leading to premature wear during ball stroke, or may disengage the ball trunnion from the trunnion bearing.

Other challenges in forming the top-entry ball valve with pressure seal may include, in the case of a lever or a valve operator mounted on the bonnet and a floating pressure seal bonnet free to move along the stem axis, the position of the actuator being not fixed. It could have an impact on the piping and cables connected to the actuators. In addition, because of the lack of rigidity, it could also induce a low natural frequency response of the assembly bonnet, bracket and actuator. A low frequency response could be mechanically dramatic for the assembly in case of seismic conditions.

The top-entry ball valve incorporating a pressure seal bonnet provided in this disclosure addresses each of the above design challenges to form a valve that can provide improved ease of maintenance, improved maneuverability in tight spaces, and improves safety and reliability. It is also more compact and lighter than conventional top-entry ball valves.

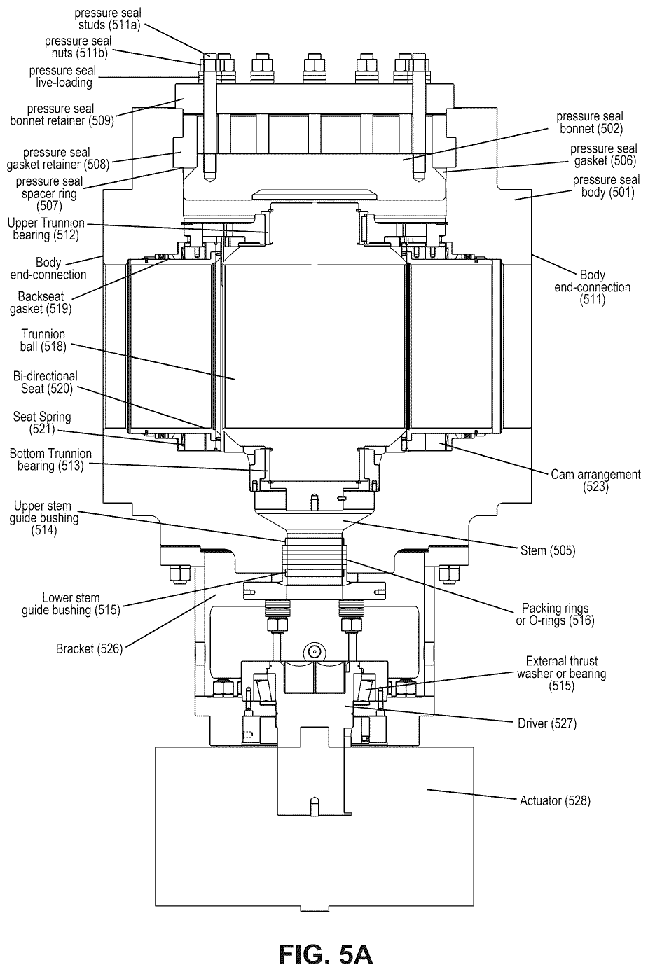

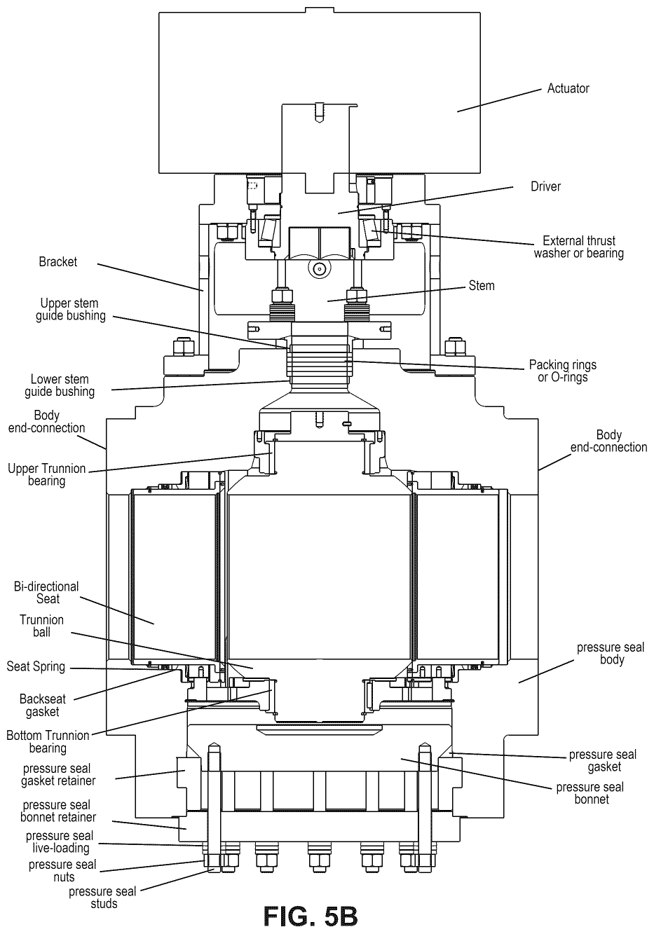

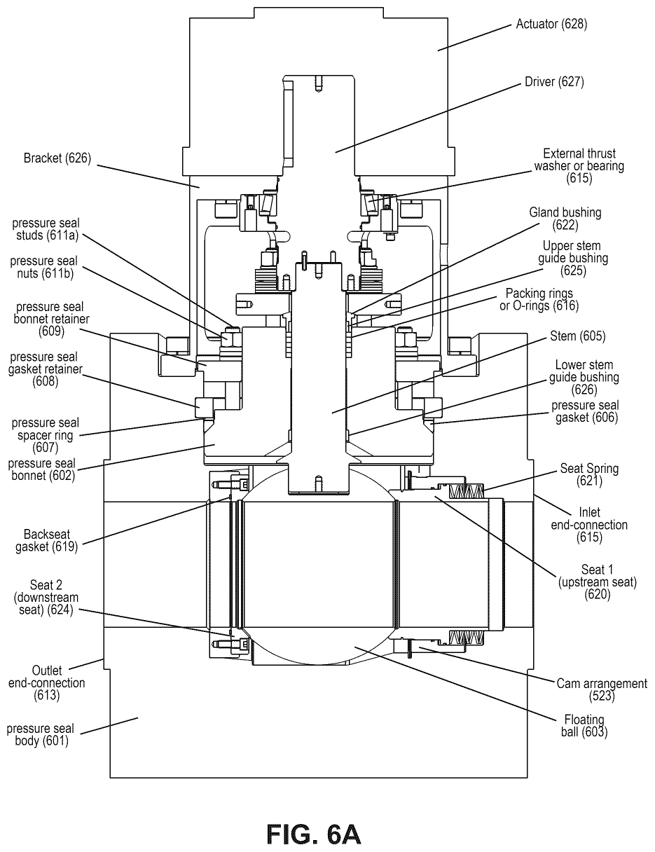

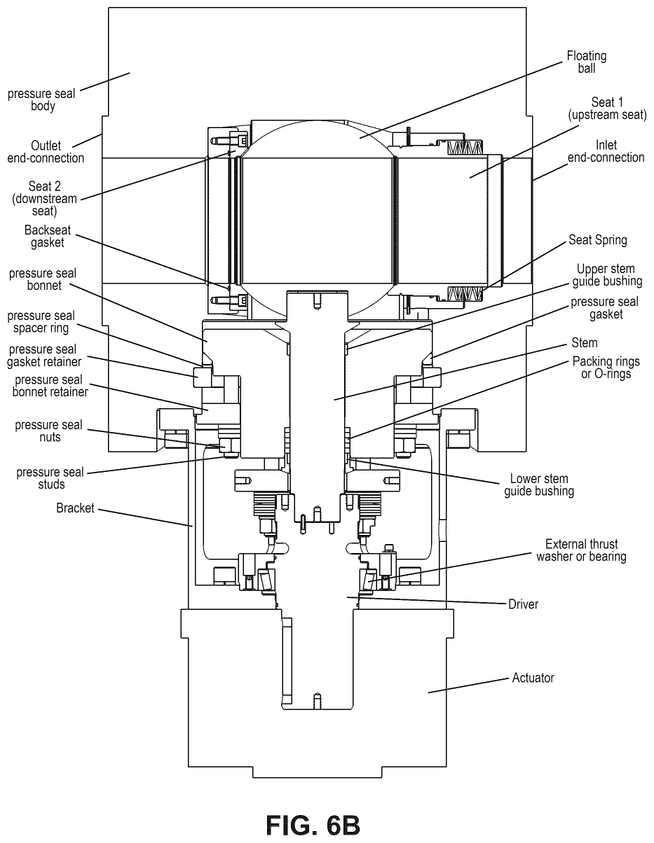

According to embodiments of this disclosure, the valve is a top-entry ball valve design with a pressure seal arrangement between the body and the bonnet. The pressure seal arrangement and bonnet could be located either in between the body and the actuator or on the body side opposite to the actuator. FIG. 5A and FIG. 6A show two different example embodiments of the top-entry ball valve with pressure seal bonnet, according to some embodiments of the present disclosure.

FIG. 5A shows a top-entry ball valve with pressure seal bonnet (502), according to an embodiment of this disclosure. In this configuration, the stem (505) is inserted from the top and protrudes the body (501). There is no stem inserted in the floating bonnet (502).

This configuration also shows the trunnion mounted ball (518) configuration guided by an upper and a lower trunnion bearing (512 and 513, respectively). The trunnion mounted ball configuration may be preferred for high pressure and large valve sizes (e.g., equal or larger than NPS6) as it allows for significantly reducing the torque required to open the ball (518) against a differential of pressure.

Both seats (bidirectional seat 520) are symmetrical and preloaded against the ball 518 with seats springs 521. Behind each seat 520, there is a pressure energized backseat gasket 519 that ensures no leakage between the body 501 and the seat 520 and positively increases the preload between the seat 520 and the ball 518 when the inlet medium pressure increases. This symmetric seat configuration allows the valve to be bi-directional.

An advantage of the configuration depicted in FIG. 5A is that the maintenance of the valve is significantly improved. Compared to a standard top-entry ball valve, there is no need to remove the bracket and the actuator to have access to the valve bonnet retainer (509) and the bonnet (502). The bonnet retainer (509) is directly accessible. In addition, once the bonnet 502 is removed, the maintenance operator has direct access to the internals of the valve (ball, seats, trunnions, etc.). This configuration helps at reducing the maintenance operator time on the valve especially in nuclear radioactive environments.

FIG. 6A shows a top-entry ball valve with pressure seal bonnet 600, according to another embodiment. In this configuration, the stem (605) is inserted in and protruding the floating bonnet (602). There is no extra drilled hole in the body (601) on the opposite side of the actuator for stem access.

It shows the ball 603 in the floating configuration. This means that the ball is solely supported by the seats (e.g., upstream seat 620 and downstream seat 624).

The two different seats (e.g., upstream seat 620 and downstream seat 624) are provided for uni-directional application. The inlet seat 620 is floating and preloaded against the ball using seat springs 621. There is no requirement for a backseat gasket. The outlet seat 624 could be crimped to the body, bolted to the body, welded to the valve body or integral to the valve body. In the case of the crimped or bolted seat configurations, there is a need for a backseat gasket to ensure no leakage between the body and the outlet seat. In the case of a welded seat to the body, the weld deposit between the seat and the body acts a sealing barrier to prevent leakage behind the seat. In the case where the seat is machined as part of the body (configuration called integral seat), there is no need for a gasket. The illustrated configuration includes a backseat gasket 619.

An advantage of the configuration depicted in FIG. 6A is that it reduces the number of potential leak paths compared to the configuration shown in FIG. 5A (e.g., no extra drilled hole in the body). In addition, all the maintenance operations (e.g., internals interchanging, packing rings maintenance, pressure seal gasket maintenance, actuator maintenance) are executed on one side of the valve only and there is no need for extra maintenance clearance on the body side opposite to the actuator.

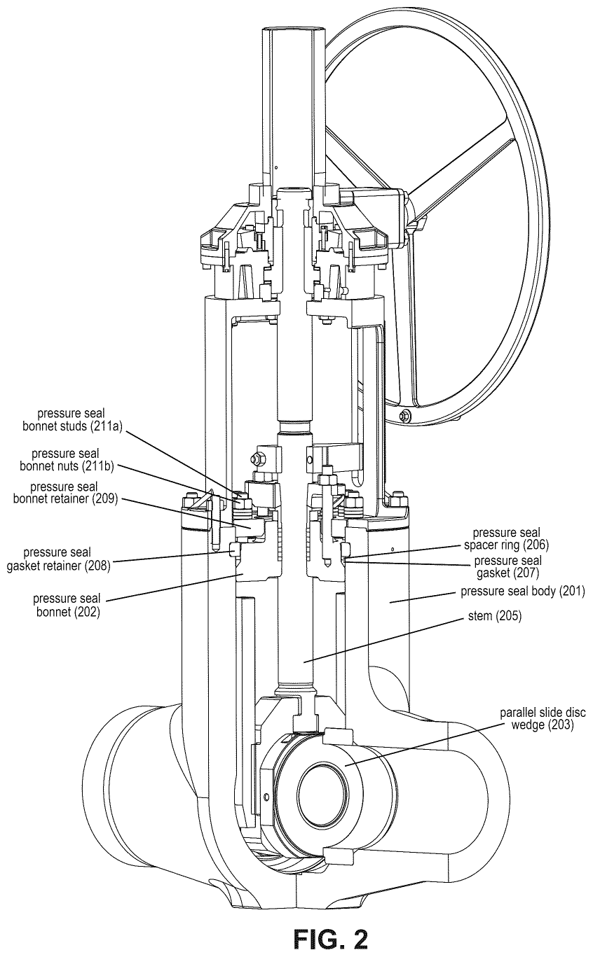

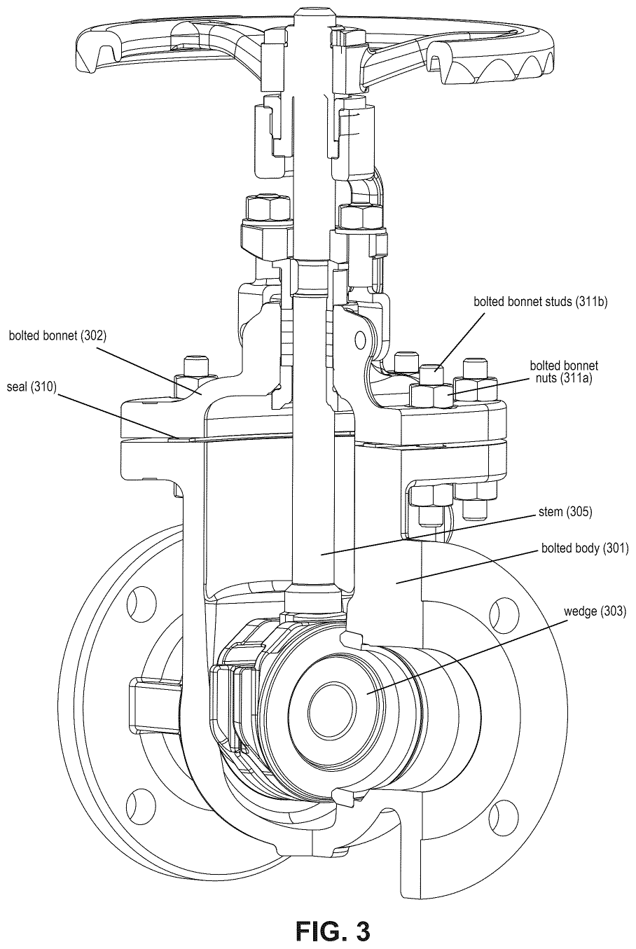

The pressure seal arrangement in example embodiments is similar to the multi-turn pressure seal valve described in relation to FIG. 2 and is composed of a pressure seal gasket (506, 606) encapsulated in between a floating pressure seal bonnet (502, 602), a spacer ring (507, 607) and a pressure seal body (valve body 501, 601). The spacer ring (507, 607) is locked in position by a gasket retainer (508, 608).

In order to create the initial seal of the bonnet (502, 602) under low internal pressure, the bonnet is compressed to the gasket (506, 606) using studs (511a, 611a) and nuts (511b, 611b) and a bonnet retainer plate (509, 609) seating on the body (501, 601).

The fluid passing through the valve (500, 600) can be isolated by a quarter-turn (e.g., 90 degree) rotation of a ball that can either be floating (603) or trunnion mounted (518).

In the case of a trunnion mounted ball, both the upper and lower ball trunnions are respectively guided by upper (512) and lower (513) trunnion bearings.

The design may use hard materials (coating, welding, plating, diffusion) on the ball, seats sealing surfaces as well as on the trunnion bearing surfaces. Because a significant portion of the powerplants processes operate at temperatures higher than the limit for polymer materials, soft materials for internals are usually proscribed.

Independently of the ball configuration, the seat arrangement can be fully symmetric for bi-directional sealing capabilities (i.e., same sealing performance on both sides of the valve) or could be designed for uni-directional sealing capabilities with different seat arrangements on the upstream or downstream the ball (i.e., valve designed to seal in one preferred direction only). Both the bi-directional seat and the uni-directional upstream seat arrangements are preloaded using seat springs (521, 621). These seat springs provide the initial required ball and seat preload and induced bearing stress between the seat sealing surface and the ball to seal against low pressure. Both the bi-directional seat and the uni-directional crimped or bolted downstream seat arrangements use backseat gaskets (519, 619) to ensure that there is no leakage between the body and the seats.

The ball quarter-turn motion is operated by a stem (505, 605). The stem (505, 605) could either be inserted in the floating pressure seal bonnet with its top-connection protruding outside the bonnet or could be inserted in the body with its top-connection protruding outside the body shell, opposite to the pressure seal bonnet.

The stem (505, 605) is guided in the bonnet (502, 602) or the body (501, 601) using lower and upper stem guide bushings (515 and 514 respectively in valve 500, 626 and 625 respectively in valve 600). These guide bushings are encapsulated in the bonnet or the gland bushing (622) and are arranged to follow the displacement of the pressure seal bonnet. Therefore, and independently of the position of the floating pressure seal bonnet (502, 602), the stem bushing guidance ensures concentricity of the stem with the packing rings and/or O-rings (516, 616) that prevent any leakage between the stem (605) and the bonnet (602) in the case of FIG. 6 or the stem (505) and the body (501) in the case of FIG. 5.

The valve internal pressure creates a stem piston effect (i.e., a load to exit the stem outside the valve). This piston effect is countered by an external driver (527, 627), and an external thrust washer or bearing (515, 615) encapsulated in a bracket (526, 626). The bracket (526, 626) is directly bolted to the pressure seal body (501, 601). As a results, and independently of the position of the floating pressure seal bonnet (502, 602), the external thrust washer or bearing (515, 615) locks the driver (527, 627) and the stem (505, 605) in position along the stem axis and ensures a constant torque transmission engagement of the stem (505, 605) with the ball (518, 603). This constant engagement ensures no alteration of the total torque that can be transmitted from stem to ball.

The valve has two seat arrangements such as, for example, upstream seat 620 and downstream seat 624. The seat arrangements are inserted from the body/bonnet opening (e.g., opening in the body 601 when the bonnet 602 is removed) independently of the bonnet position (body seal facing the actuator or opposite to the actuator), either on the bottom or on the top of the valve assembly.

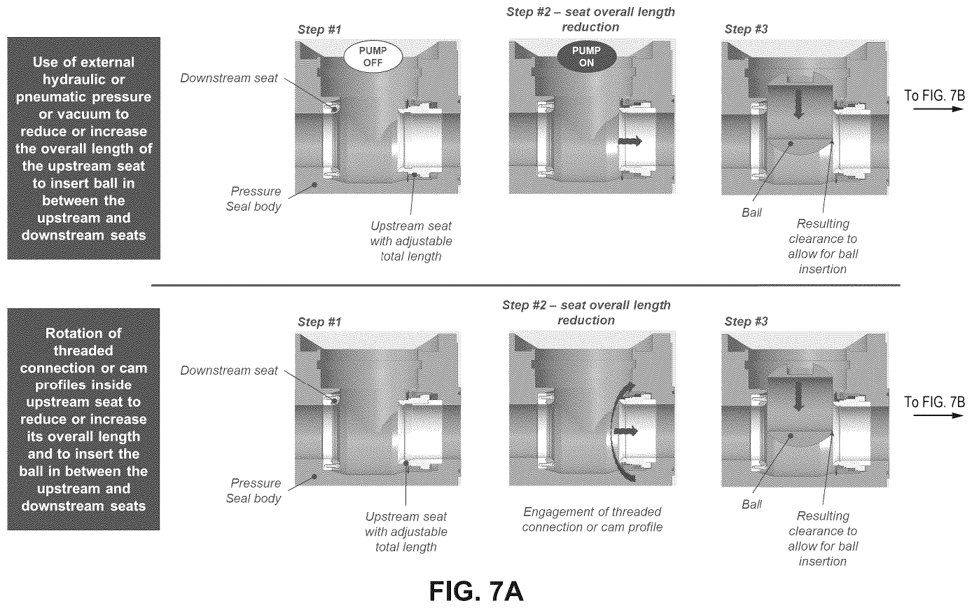

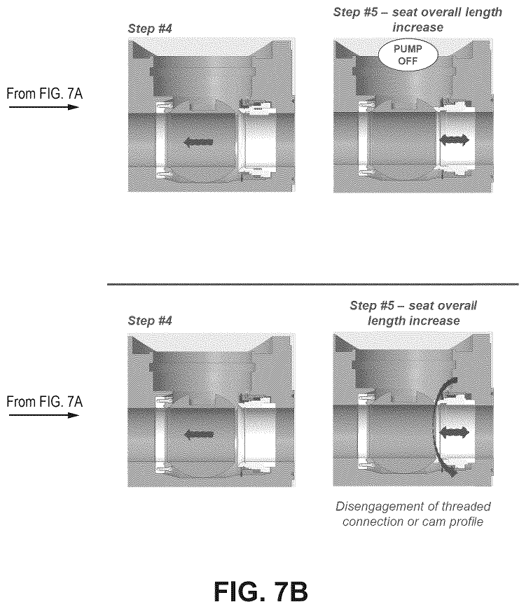

The seat arrangements have the capability to be reduced or extended by either the use of cams integrated into the seat arrangements, threads integrated into the seat arrangements, the use of external hydraulic pressure or pneumatic pressure or vacuum (FIG. 7). In the case of hydraulic pressure or pneumatic pressure or vacuum, an external positive hydraulic or pneumatic or vacuum pump is connected to the valve pressure seal body or upstream seat. The activation of the pump system changes the pressure inside the upstream seat arrangement or in between the upstream seat arrangement and the pressure seal body. This change of pressure reduces the overall length of the upstream seat arrangement and creates enough clearance within the body cavity and in between the two seats to insert the ball. Once the ball is properly located in between the two seats, the pump system is deactivated and the upstream seat arrangement gradually expands until the seat sealing surface gets into contact with the ball. The disassembly process of the ball with a positive hydraulic or pneumatic or vacuum pump is the opposite of the assembly process.

In the case of a threaded connection or a cam profile connection inside the upstream seat arrangement or the pressure seal body, the operation of ball assembly is completed manually or using a wrench for the larger sizes. By engaging by hand or with a wrench the internal threaded connection or by rotating the cam profile inside the upstream seat arrangement or the pressure seal body, the overall length of the seat is reduced enough to create a clearance within the body cavity and in between the two seats to insert the ball. Once the ball is properly located in between the two seats, the internal thread is disengaged, or the cam profile is rotated in the opposite direction until the upstream seat sealing surface gets into contact with the ball. The disassembly methodology of the ball with an internal threaded connection or an internal cam profile is the opposite of the assembly one. Example cam arrangements 523 and 623 are shown in FIGS. 5A and 6A.

FIG. 7 shows a uni-directional seat arrangement and floating ball design configuration. The same methodologies can apply to the bi-directional seat arrangement and the trunnion ball design configuration. Once the ball is well located between the two retracted seats, the systems of cams integrated into the seats, threads integrated into the seats, the use of external hydraulic pressure or pneumatic pressure or vacuum are used to extend the seats to the point where the seat sealing surface enters into contact with the ball sphere.

FIG. 5B illustrates the same arrangement as FIG. 5A, but with the pressure seal arrangement and bonnet located on the bottom of the valve and actuator assembly. FIG. 6B illustrates the same arrangement as FIG. 6A, but with the pressure seal arrangement and bonnet located on the bottom of the valve and actuator assembly. The arrangements depicted in FIGS. 5B and 6B do not alter the overall performance of the valve compared to FIGS. 5A and 6A. These arrangements could be convenient for power plants with limited clearances above the valve that do limit or make impossible the internals maintenance from the top of the valve.

In the embodiments illustrated in FIGS. 5A-6B, each of the potential paths (e.g., from the stem connection passing through an aperture in the body or between the stem and stem sealing arrangements) from which the highly pressurized process flow in the valve's flow path may leak to the ambient environment has been mitigated by either elimination of that potential path or by appropriate sealing structures. Although each of these potential leak paths in the embodiments illustrated in FIGS. 5A-6B is provided with sealing structures attempting to prevent or limit actual leakage, such seals may not be 100% effective and/or may deteriorate over time to permit some leakage. The embodiments illustrated in FIGS. 5A-6B allow for replacing each individual seal by a series of seals to reduce further the risk of leak over time.

In each of the example embodiments of FIGS. 5A-6B, the valve body is preferably machined from a single block of metal. The bonnet is also preferably machined from a single block of metal. This two-piece valve shell structure reduces potential leakage paths to only two: (1) a path passing between the body and the bonnet and (2) a path passing between bonnet and the stem. All embodiments illustrated in FIGS. 5A-6B permit fixing (permanently or temporarily) a torque monitoring transducer on the stem or driver or bracket or at the interface between these components for monitoring a resulting valve operating torque. All embodiments illustrated in FIGS. 5A-6B permit fixing (permanently or temporarily) an angular position monitoring transducer on the stem or driver or bracket or at the interface between these components for monitoring the ball position. An acoustic transducer can also be mounted on the body near a seat (or bonnet) to detect acoustic signals caused by steam, liquid, gas leakage past the valve seats or bonnet. One or more pressure sensor transducers can also be connected to monitor the pressure within internal body cavity including possible pressure differentials between the valve inlet and body cavity or body cavity and valve outlet. And electrical outputs from one or more of such transducers and be connected to a data acquisition system with local access or remote access to such measured data.

In addition, since during valve assembly processes, ball is inserted from the top (before the bonnet is locked in body opening by the pressure seal gasket retainer), the size of the ball and/or body (with respect to the envelope dimensions of the valve and the external constraints imposed for the valve) does not impose undue limits on the length and/or diameter of stem. This permits the valve stem to extend upwardly through a stem sealing arrangement within the bonnet including multiple packed gland stem sealing assemblies and, possibly via an intermediate driver, to be coupled upwardly to an external thrust bearing (which not only reduces rotational friction but also provides a downwardly directed force to assist in keeping the valve stem properly located in the valve assembly). As will be appreciated, the top-entry design also permits the stem itself to extend directly to the external thrust bearing (i.e., without an intermediate driver).

The stem in any of the example embodiments of FIGS. 5A-6B can be a separate structure coupled to a floating or trunnion mounted ball. Alternatively, the stem and ball can be made as a single integral part for added strength and reduction in number of parts to be assembled.

The embodiments of FIGS. 5A-6B show a single ball and pair of seats in a body made of a single block of metal. However, the body could be made of a longer or larger single block of metal to have several body cavities and body top-openings to accommodate several balls with mating pair of seats. The body could be designed so that the balls and mating pair of seats in series or in parallel.

The body and bonnet pieces of all two-piece valve body examples are each possibly machined from a single block of a suitable hard metal like carbon steel, a corrosion resistant austenitic stainless steel, nickel-based steel or similar as may be required for a particular serviced process. Each of the valve body pieces could instead be machined from raw material (either forged or cast) or manufactured from additive manufacturing processes including 3D printing. The internal “wetted” surfaces of the valve body, bonnet, ball, seats and the like subjected to a serviced process flow are configured for power/nuclear service applications (e.g., saturated steam, superheated steam, steam condensate, water, gas and/or similar severe industrial service applications) by applying a corrosion resistant overlay of Stainless Steel (or a similar corrosion resistant metal or metal alloy suited to the serviced process, or protected by Stainless Steel sleeves (or a similar corrosion resistant metal or metal alloy), or protected by hard-coating similar to the ones used between ball and seats sealing surfaces, or the combination of the three. The Stainless Steel surface overlay may be applied by welding processes or by other processes. In some embodiments, as noted above, a sleeve of Stainless Steel or any corrosion resistant material can be fixed to the hard metal (e.g., Carbon Steel LF2) body shell using welding and complex geometries. Interconnecting Stainless Steel sleeves can be accomplished by welding between each sleeve.

In an embodiment, a top entry ball valve for severe industrial applications such as power and nuclear applications is provided. The top entry ball valve comprises a single piece metal body, a rotatable metal valve structure, a top opening arranged on the body and sized to accept entry of the metal valve structure and its associated seats, a single piece metal bonnet configured for pressure seal connection to the top of said body, and a rotatable valve operating stem integral with or operatively connected to the top of said metal valve structure so as to rotate the metal valve structure when the stem is rotated.

The rotatable metal valve structure may be fitted within said body between metal valve seats also fitted into said body, said valve seats making metal-to-metal sealing engagement with said metal valve structure, said metal valve structure having an aperture there-through for passing a fluid flow when in a predetermined open rotational position and for blocking a fluid flow when in a predetermined closed rotational position.

The top entry valve of previous two paragraphs above wherein the pressure seal connection between the body and the bonnet comprises of circular retaining mechanism acting as a barrier to prevent the bonnet and a pressure seal gasket exiting the valve. Alternatively, the top entry valve of previous two paragraphs above wherein the bonnet and the pressure seal are installed on a side of the body opposite to an operator. Alternatively, the top entry valve of previous two paragraphs above wherein said bonnet and the pressure seal are installed on a side of the body facing an operator.

The top entry valve of the previous paragraph wherein said bonnet and the pressure seal are installed on a side of the body facing an operator, further wherein the body includes an aperture on the opposite side of the top opening to accept a stem and a stem sealing arrangement comprising a pair of rotor seals circumferentially disposed around the rotatable stem.

The top entry valve of the paragraph before the previous paragraph wherein said bonnet and the pressure seal are installed on a side of the body facing an operator, further wherein the bonnet includes an aperture to accept a stem and a stem sealing arrangement comprising a pair of rotor seals circumferentially disposed around the rotatable stem.

The top entry valve of the previous paragraph wherein the valve is configured to enable the operator to have direct access to replace the complete metal valve structure, its associated seats and the stem without removing an actuator or bracket of the valve.

The top entry valve of the paragraph before the previous paragraph where the stem is maintained in a concentric position with the body aperture using encapsulated stem bushing.

The top entry valve of the paragraph two paragraphs before the previous paragraph where the stem is maintained in a concentric position with the pressure seal bonnet aperture using encapsulated stem bushing.

The top entry valve of either of the previous two paragraphs where the stem is maintained in position in the valve and in interface with the metal valve structure using an external bracket bolted to the body, an external thrust bearing encapsulated inside the bracket and a driver in contact with the thrust bearing.

The top entry valve of the paragraph eight paragraphs above, where the seat assemblies have an adjustable total length using external hydraulic or pneumatic pressure, or vacuum, or threads between subcomponents of the seat assembly, or cam profiles between subcomponents of the seat assembly, wherein an adjustment is completed when the pressure seal bonnet is not physically attached to the body.

The top entry valve of the previous paragraph where the metal valve structure, upper and lower trunnion bearings can be assembled in between the two seat assemblies when the seat assemblies total length is reduced.

The top entry valve of the previous paragraph where the metal valve structure and the seats are configured to act as sealing barrier when the seat assemblies total length is increased.

The top entry valve of the paragraph eleven paragraphs above, wherein said metal valve structure is a ball-shaped structure having an aperture there-through for passing a valved process fluid.

The top entry valve of the paragraph twelve paragraphs above, wherein said ball shaped structure is a floating ball connected at a top side with a separately formed stem structure.

The top entry valve of the paragraph thirteen paragraphs above, wherein said ball shaped structure and the stem structure are combined together into a single unitary structure.

The top entry valve of the paragraph fourteen paragraphs above, wherein said ball shaped structure includes trunnion mounting cylindrical portions at opposite top and bottom sides interfacing between the ball and the body

The top entry valve of the paragraph fifteen paragraphs above, wherein the valve includes internal movable members spring-loaded towards the center of the valve.

The top entry valve of the paragraph sixteen paragraphs above, wherein said body and the bonnet are retained together with a pressure seal arrangement and pressure seal gasket retainer.

The top entry valve of the paragraph seventeen paragraphs above, wherein the metal valve structure is a rotatable cylindrical or conical plug structure.

The top entry valve of the paragraph eighteen paragraphs above, wherein one or more wetted surfaces of the body and bonnet are protected with corrosion resistant sleeves.

In an embodiment, a method of making a top entry valve for power and nuclear industrial applications is provided.

The method includes providing a single piece metal valve body having a top opening, providing a rotatable metal valve structure sized to fit through said top opening of the valve body, and fitting the metal valve structure within the body through said top opening between metal valve seats also fitted into the body through the top opening. The valve seats make metal-to-metal sealing engagement with said metal valve structure, the metal valve structure has an aperture there-through for passing a fluid flow when in a predetermined open rotational position and blocks a fluid flow when in a predetermined closed rotational position.

The method also includes providing a single piece metal bonnet configured for pressure seal connection to the top of said body, providing aperture in the body or the bonnet, fitting a rotatable valve operating stem, integral with or operatively connectable to the top of said metal valve structure, within rotator seals about its circumference, through the body or the bonnet so as to rotate the metal valve structure when the stem is rotated.

The method of the two previous paragraphs may be used in the construction and/or deployment of a valve according to any one or more paragraphs between twenty three paragraphs above to four paragraphs above.

Although the above examples have employed a metallic ball and metallic seats, in another example these components can be made of ceramic materials or polymer materials. Manufacturing these components in ceramic or polymer materials would have an impact on their envelope dimensions, the overall dimensions of the valve and the limit of temperature operation. However, the example design concepts can be adjusted to allow for interchanging metallic and ceramic ball and metallic, ceramic and polymer seats in the same body of prior examples.

While the invention has been described in connection with what is presently considered to be the most practical and preferred example embodiments, it is to be understood that the invention is not limited to the disclosed example embodiments, but on the contrary, is intended to cover various modifications and equivalent arrangements included within the spirit and scope of the appended claims. As those in the art will appreciate, some individual features of one example embodiment may be also used in another example embodiment.

1. A top entry ball valve for severe industrial applications especially power and nuclear applications, said top entry valve comprising:
a single piece metal body;
a rotatable metal valve structure, said metal valve structure being fitted within said body between metal valve seats also fitted into said body, said valve seats making metal-to-metal sealing engagement with said metal valve structure, said metal valve structure having an aperture there-through for passing a fluid flow when in a predetermined open rotational position and for blocking a fluid flow when in a predetermined closed rotational position;
said body including a top opening sized to accept entry of the metal valve structure and its associated seats;
a single piece metal bonnet configured for pressure seal connection to the top of said body; and
a rotatable valve operating stem integral with or operatively connected to the top of said metal valve structure so as to rotate the metal valve structure when the stem is rotated.

2. The top entry valve of claim 1 wherein the pressure seal connection between the body and the bonnet comprises of circular retaining mechanism acting as a barrier to prevent the bonnet and a pressure seal gasket exiting the valve.

3. The top entry valve of claim 2 wherein said bonnet and the pressure seal are installed on a side of the body opposite to an operator.

4. The top entry valve of claim 2 wherein said bonnet and the pressure seal are installed on a side of the body facing an operator.

5. The top entry valve of claim 4 wherein the body includes an aperture on the opposite side of the top opening to accept a stem and a stem sealing arrangement comprising a pair of rotor seals circumferentially disposed around the rotatable stem.

6. The top entry valve of claim 4 wherein the bonnet includes an aperture to accept a stem and a stem sealing arrangement comprising a pair of rotor seals circumferentially disposed around the rotatable stem.

7. The top entry valve of claim 6 wherein the valve is configured to enable the operator to have direct access to replace the complete metal valve structure, its associated seats and the stem without removing an actuator or bracket of the valve.

8. The top entry valve of claim 6 where the stem is maintained in a concentric position with the body aperture using encapsulated stem bushing.

9. The top entry valve of claim 6 where the stem is maintained in a concentric position with the pressure seal bonnet aperture using encapsulated stem bushing.

10. The top entry valve of claim 8 where the stem is maintained in position in the valve and in interface with the metal valve structure using an external bracket bolted to the body, an external thrust bearing encapsulated inside the bracket and a driver in contact with the thrust bearing.

11. The top entry valve of claim 1 where the seat assemblies have an adjustable total length using external hydraulic or pneumatic pressure, or vacuum, or threads between subcomponents of the seat assembly, or cam profiles between subcomponents of the seat assembly, wherein an adjustment is completed when the pressure seal bonnet is not physically attached to the body.

12. The top entry valve of claim 11 where the metal valve structure, upper and lower trunnion bearings can be assembled in between the two seat assemblies when the seat assemblies total length is reduced.

13. The top entry valve of claim 12 where the metal valve structure and the seats are configured to act as sealing barrier when the seat assemblies total length is increased.

14. The top entry valve of claim 1 wherein said metal valve structure is a ball-shaped structure having an aperture there-through for passing a valved process fluid.

15. The top entry valve of claim 1 wherein said ball shaped structure is a floating ball connected at a top side with a separately formed stem structure.

16. The top entry valve of claim 1 wherein said ball shaped structure and the stem structure are combined together into a single unitary structure.

17. The top entry valve of claim 1 wherein said ball shaped structure includes trunnion mounting cylindrical portions at opposite top and bottom sides interfacing between the ball and the body.

18. The top entry valve of claim 1 including internal movable members spring-loaded towards the center of the valve.

19. The top entry valve of claim 1 wherein said body and the bonnet are retained together with a pressure seal arrangement and pressure seal gasket retainer.

20. The top entry valve of claim 1 wherein the metal valve structure is a rotatable cylindrical or conical plug structure.

21. The top entry valve of claim 1 wherein one or more wetted surfaces of the body and bonnet are protected with corrosion resistant sleeves.

22. A method of making a top entry valve for power and nuclear industrial applications, said method comprising:
providing a single piece metal valve body having a top opening;
providing a rotatable metal valve structure sized to fit through said top opening of the valve body,
fitting said metal valve structure within said body through said top opening between metal valve seats also fitted into said body through said top opening, said valve seats making metal-to-metal sealing engagement with said metal valve structure, said metal valve structure having an aperture there-through for passing a fluid flow when in a predetermined open rotational position and for blocking a fluid flow when in a predetermined closed rotational position;
providing a single piece metal bonnet configured for pressure seal connection to the top of said body;
providing aperture in the body or the bonnet;
fitting a rotatable valve operating stem, integral with or operatively connectable to the top of said metal valve structure, within rotator seals about its circumference, through the body or the bonnet so as to rotate the metal valve structure when the stem is rotated.
